(19) United States
(12) Patent Application Publication
(10) Pub. No.: US 2002/0059479 A1
(43) Pub. Date: May 16, 2002

(54) Programmable adapter device for communication protocols

(76) Inventors: Christian Hardy, Le Thoronet (FR); Frederic Puig, Valbonne (FR); Philippe Barthelemy, Biot (FR)

Correspondence Address: PARKHURST & WENDEL, L.L.P., Suite 210, 1421 Prince Street, Alexandria, VA, 22314-2805, US

(21) Appl. No.: 09/986,641

(22) Filed: Nov. 9, 2001

(30) Foreign Application Priority Data
Nov. 14, 2000 (FR) 00 14755

(51) Int. Cl. G06F 3/00

(52) U.S. Cl. 710/1

(57) ABSTRACT

This invention relates to a programmable adapter device between a higher level communication protocol supported by a higher level equipment (30) and at least one lower level communication protocol supported by a lower level automation equipment (40). The device comprises an adapter (20) provided with a first memory (25) containing a conversion program (15) between the higher level protocol and a lower level protocol, downloadable from the higher level equipment (30) and that can be executed by the adapter (20), and provided with a second non-volatile memory (26) containing a resident driver program (16) in order to initialise communication with the higher level equipment (30). A memory area (17) is used as an intermediate buffer to manage asynchronism between protocols. The lower level connecting cable (14) is used to identify a complete or partial identifier of the lower level protocol.

This invention relates to a programmable adapter device capable of creating a communication between two items of equipment including different communication protocols. It also relates to a process to automatically configure such an adapter device with a given protocol.

In general, serial communication between computers, for example such as a PC (Personal Computer) or a PDA (Personal Digital Assistant) type equipment, and other equipment such as automation equipment, is only possible it the two items of equipment can understand the same communication protocol. In this context, the term “automation equipment” includes a programmable logic controller, a numerical control, regulation device, instrumentation/control station, a man-machine dialogue terminal, a speed controller, an intelligent sensor/actuator or any other type of equipment connected to automation that has a processing unit and is capable of communicating with external equipment.

A wide variety of different and specific communication protocols is used in automation equipment. Drivers for these communication protocols have often been developed under the assumption that a UART (Universal Asynchronous Receiver and Transmitter) hardware interface on computers can be directly controlled. However, the fast change to computers causes major modifications to peripheral drivers, UARTs, and operating systems for this equipment making it difficult to make them compatible with the large quantities of existing automation equipment using different communication protocols. Furthermore, computers have fewer and fewer real COM serial communication ports, that are being replaced by standard peripheral buses such as the USB (universal Serial Bus).

If a driver is capable of controlling a UART directly, and for a “half-duplex” type communication for which the communication line physically has two states, one of which enables transmission and the other enables reception of data, it is usually assumed that the driver can switch the line from sending and receiving sufficiently precisely after all characters have left the UART transmission registers and before the automation equipment answers. This assumption is true for equipment with direct control over a UART, but it is wrong for a complex, multi-task machine architectured in hardware layers and software layers such as a personal PC type computer.

In other cases, the transport level protocol (Data Link) is such that a maximum inter-character time must be respected in order to identify correct transmission. For performance reasons, this inter-character time is of the same order of magnitude as the character transmission time (for example at 38 300 bauds=1/38400*11*1.5=430 microseconds). In these cases, it is difficult to control the waiting time (that varies from 100 microseconds to 1 millisecond) since it is too long to be managed by scanning when masked by interrupts (waste of cycles in the CPU processing unit) and too short compared with the time instability (jitter) induced by the system (multitask, exchanges of blocks on the video bus, energy management).

Therefore, “minimum delay” and “maximum delay” type constraints have to be implemented. “Minimum delay” type constraints impose large safety margins and therefore a loss of performance. For “maximum delay” type constraints, tricks have to be used that are incompatible with the rules of the art of development: waiting in loop, locking of interrupts, short circuits of software layers, addition of proprietary electronic components, etc., to the detriment of portability and the general performance of the communicating machine, and even then there are no guaranteed results.

Document U.S. Pat. No. 5,870,626 discloses a device for making a data processing link between several items of equipment using heterogeneous communications protocols. In this device, an interface is connected firstly to one or several computers at the higher level and also to one or several items of equipment at the lower level. These links are made using connecting cables that must be provided with identification keys to enable identification of the communication protocol used by the corresponding equipment or computer. The interface comprises a central processor with a library of protocol conversion programs associated with each of the identification keys. Nevertheless, since the identification keys are specific to the connecting cables, this device imposes the use of specific cables and consequently it is not suitable for monitoring regular software upgrades to communication protocols. Furthermore, this type of solution may make expensive computer resources necessary at the interface to manage and memorize the different possible combinations between the higher and lower level protocols.

A first purpose of this invention is to propose a simple solution to avoid reliability problems encountered in communications between computer equipment and automation equipment communicating with different communication protocols. Another purpose is firstly to quickly adapt to accommodate software upgrades to communication protocols and also to avoid high extra costs induced by updates to communication protocol drivers so that they can be modified to satisfy the ongoing changes to computer equipment. This improvement is made by shifting processing in which is time is critical into a programmable adapter, while keeping all peripheral drivers in the computer equipment on the higher level with existing drivers. Another purpose of this invention is to optimise waiting and switching times in a half-duplex communication, in order to increase the useable communication speed range and to provide a simple and inexpensive solution particularly for management of the higher level protocol.

Furthermore, by inserting a programmable adapter between the higher and lower level networks, the invention reduces the problem related to the large number of cables for the lower level which are usually different depending on the lower level equipment to which they provide access, even when the same protocol is used. The length of the lower level cables can be shortened (to about 10 cm), for an increase in the length of the higher level support cable (of the order of several meters).

To achieve this, the invention describes a programmable adapter device between a higher level communication protocol integrated into the higher level equipment such as a computer, and at least one lower level communication protocol included in the lower level equipment such as automation equipment. The device comprises an adapter fitted with a processing unit capable of executing program instructions, a higher level interface that can connect with a higher level interface in the higher level equipment, and a lower level interface that can connect with a lower level interface on the lower level equipment. The device is characterised by the fact that the adapter comprises a first memory that may be volatile containing a conversion program between the higher level protocol and a lower level protocol, that can be downloaded from the higher level equipment and executed by the adapter processing unit, and by the fact that the adapter comprises a second non-volatile memory containing a resident driver program that can be executed by the processing unit in order to initialise communication with the higher level equipment using the higher level protocol and download the conversion program into the first memory.

According to one characteristic, the adapter device comprises a lower level connecting cable between the lower level interface of the adapter and the lower level interface of the lower level equipment, this lower level connecting cable comprising recognition means that can be detected when the cable is connected to the lower level interface of the adapter, enabling the adapter processing unit to determine a complete or partial identifier of the lower level protocol using the driver program resident in the second adapter memory. The higher level equipment comprises a storage area that is capable of storing one or several conversion programs between the higher level protocol and the lower level protocol, that can be downloaded into the adapter when the lower level protocol has been identified.

The invention also describes a process for configuration of an adapter device comprising a recognition step in which the adapter determines and memorizes a complete or partial lower level protocol identifier starting from means of recognition of the lower level connecting cable connected to the adapter; a first identification step in which the adapter communicates with the higher level equipment using the higher level communication protocol to send the lower level protocol identifier to it; a first downloading step in which higher level equipment downloads a first conversion program between the higher level protocol and the lower level protocol corresponding to the transmitted lower level protocol identifier, into the adapter.

If the identifier transmitted to the higher level equipment during the first identification step is a partial identifier, the process comprises the following additional steps; a learning step in which the adapter communicates with the lower level equipment according to the first conversion program downloaded during the first downloading step in order to define and memorize a complete identifier of the lower level protocol; a second identification step in which the adapter communicates with the higher level equipment to transmit this complete identifier to it; a second downloading step in which the higher level equipment downloads a second conversion program into the adapter, to make the conversion between the higher and lower level protocols corresponding to the complete identifier of the lower level protocol.

With this adapter device and its configuration process, it would be possible to automatically download a given protocol into the adapter to make two items of equipment including different communication protocols communicate transparently or in “plug and play” for a user. Furthermore, with a single programmable adapter, in the future it will be possible to make a conversion between a higher level protocol and several lower level protocols, starting from conversion programs memorized in the higher level equipment and that can be downloaded in the adapter.

Other characteristics and advantages will become clear in the following detailed description with reference to an embodiment given as an example and illustrated on the attached drawings in which:

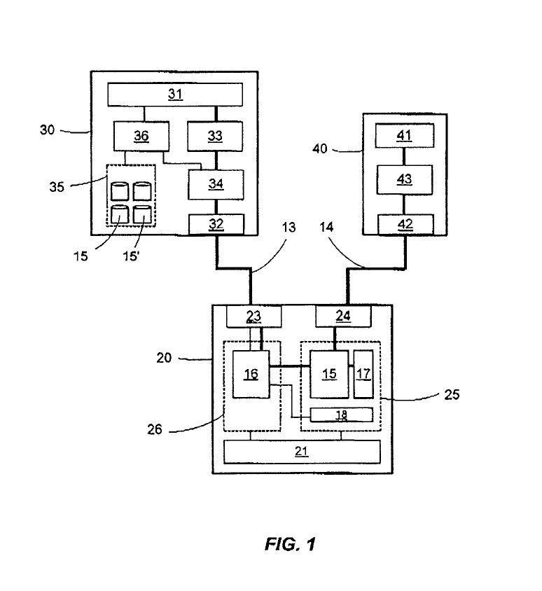

FIG. 1 represents the architecture of the programmable adapter device according to the invention,

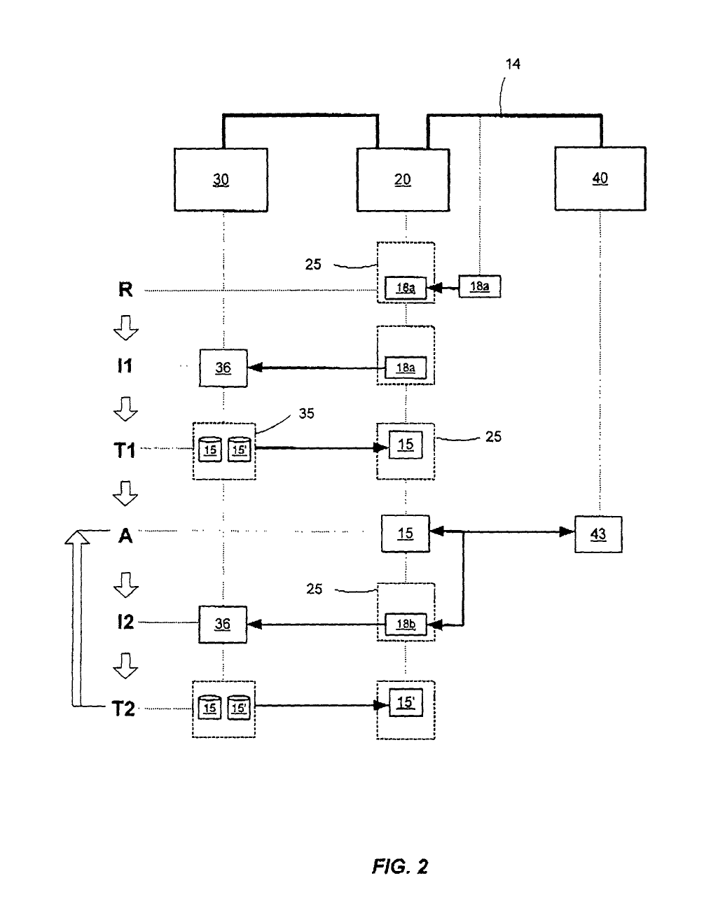

FIG. 2 diagrammatically shows steps in the configuration process related to the adapter device,

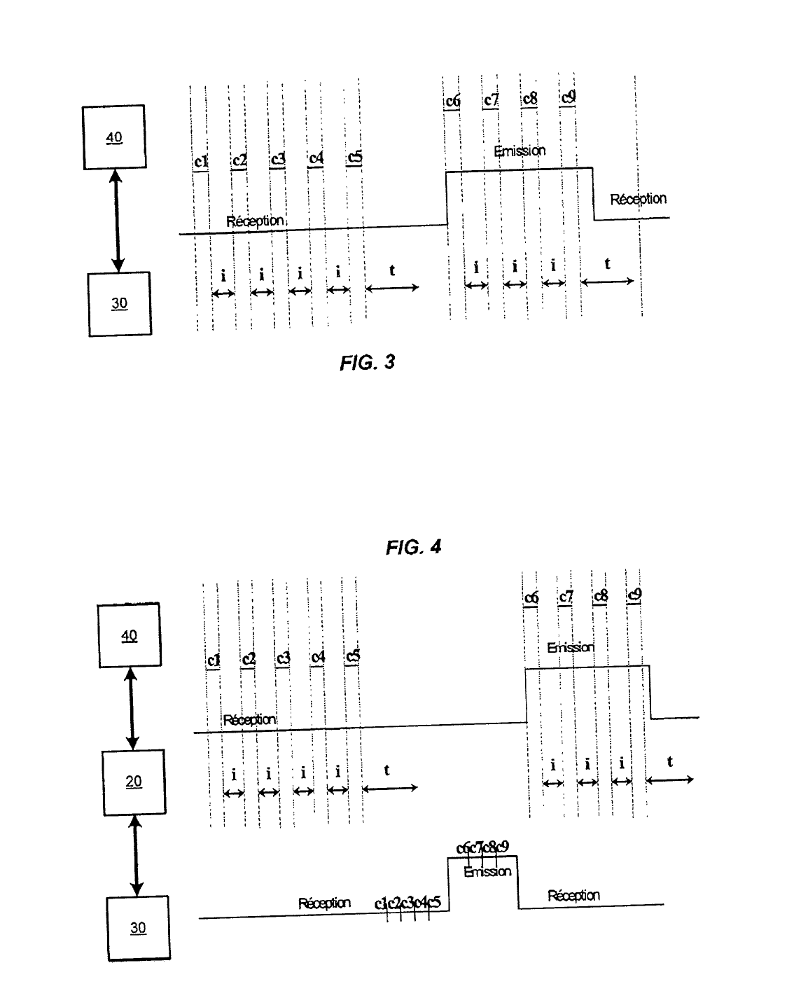

FIGS. 3 and 4 illustrate a communication example with and without the adapter device respectively.

With reference to FIG. 1, it is required to make higher level equipment 30 communicate with lower level equipment 40 through an external adapter 20. The adapter 20 is contained in an adapter box and comprises a higher level interface 23 and a lower level interface 24. The higher level equipment 30, which for example may be computer equipment as defined previously, comprises a higher level interface 32 to communicate on a higher level communication network with the higher level interface 23 of the adapter 20 using a higher level communication protocol. The higher level communication network uses a communication support 13 that may or may not be wired. The lower level equipment 40, which is preferably automation equipment as defined above, comprises a lower level interface 42 to communicate on a connecting cable 14 with the lower level interface 24 of the adapter 20 according to a lower level communication protocol. The lower level equipment 40 comprises a processing unit 41 and a lower level protocol driver 43 capable of sending and receiving the messages using the lower level protocol.

For example, the higher level communication protocol may be the USB protocol that is widely used in higher level equipment such as a PC, or the BLUETOOTH protocol (registered trademark of Ericsson) for which the communication support 13 would consist of radio waves (protocol described by the IEEE work group 802.15), the protocol according to IEEE recommendations 1394-1995 (for example such as the FIREWIRE protocol registered trademark of Apple Computer), or others. If possible, as in the case of the USB protocol, the communication support 13 also carries the electrical power supply for the adapter 20 from the USB higher level interface 32 of the higher level equipment 30.

The lower level communication protocol is preferably one of the protocols that are frequently used in the world of automation. For example, the lower level communication protocol may be the Modbus, Modbus+ or Uni-telway protocol, or any protocol with a physical layer that satisfies one of the recommended standards RS-232, RS-485, RS-422 or current loop. Similarly, the lower level communication protocol may be a protocol based on the Ethernet and TCP/IP standards, for example such as the TCP MODBUS protocol. The lower level communication protocol may also be selected from a group composed of FIP protocols (registered trademark of WorldFIP Europe), CAN, CANopen, Interbus-S (registered trademark of Phoenix Contact), DeviceNet, or others. Finally, it may be a message service protocol specific to the automation based on a USB.

The adapter 20 comprises a data processing unit 21 capable of executing program instructions related to a first volatile or non-volatile memory 25, and to a second non-volatile memory 26. The second memory 26 contains a small resident driver program 16 that can be executed by the processing unit 21. The resident driver program 16 is used particularly to initialise communication between the adapter 20 and the higher level equipment 30 according to a determined higher level communication protocol such that the adapter 20 can be used as a peripheral, to download a conversion program 15, 15′ into the first memory 25 and to provide a minimum amount of dialog to enable the higher level equipment 30 to know the state of the adapter 20. Therefore, a given adapter 20 can only communicate with the higher level equipment 30 using the higher level protocol memorized in the resident driver program 16. The resident driver program 16 may possibly contain communication primitives such as an access library to the higher level network for the conversion program 15, in order to release implementation details of the higher level network such as the chosen electronic components. Therefore, it is easy to initialise the adapter 20 and no particular protocol recognition is necessary to communicate with the higher level equipment 30.

The higher level equipment 30 comprises a processing unit 31 capable of executing program instructions, and a storage area 35 capable of memorizing one or several conversion programs 15, 15′ between a higher level protocol and one or several lower level protocols. This storage area 35 is managed by a control program 36 that is capable of downloading a conversion program 15 into the first memory 25 of the adapter. Similarly, it would also be possible to envisage that the control program 36 should access a conversion program 15 in a remote memory area accessible from the higher level equipment 30 through a LAN or global network such as Internet, rather than in the storage area 35 of the higher level equipment 30.

The conversion program thus downloaded may be executed by the processing unit 21 of the adapter 20. Each conversion program 15, 15′ receives messages sent by the higher level equipment using the higher level protocol addressed to lower level equipment, and transmits these messages to the lower level equipment using the lower level protocol. Similarly, it receives messages sent by the lower level equipment using the lower level protocol addressed to the higher level equipment, and transmits them to the higher level equipment using the higher level protocol.

The higher level equipment 30 comprises at least one peripheral driver 34 and at least one lower level peripheral driver 33. The higher level interface 32 of the higher level equipment 30 is connected to a peripheral driver 34 itself connected to a lower level protocol driver 33. The control program 36 is a program with which a user can interact, for example using a dialog interface, so that he can control the state of the peripheral driver 34, and configure it or disinstall it. Therefore, the user can activate the control program 36 to load the conversion program 15 into a first memory 25 of the adapter 20, but the program can also be started automatically by the peripheral driver 34. In fact, usually only a program (not a single peripheral driver) can access a file system in order to find a program 15, 15′ in a storage area 35.

The lower level protocol driver 33 (that is a genuine peripheral driver operating in kernel mode, or a program operating in user mode) is driven by an application program from which it receives messages to be sent and to which it sends received messages. It uses one of several possible peripheral drivers 34 to communicate with an adapter 20. The peripheral driver 34 supports a service interface that is used by the control program 36 to dialog with the adapter 20 as a peripheral on the higher level network. The peripheral driver 34 also supports a communication interface that is used by the lower level protocol driver 33. Within the context of the invention, this communication interface may be designed in several different manners depending on the problem to be solved

According to one preferred embodiment, the communication interface is a serial communication interface in accordance with the specification of serial peripheral drivers. Due to this conformity, the lower level protocol driver 33 can be supported on serial communication layers provided with the operating system of the higher level equipment 30; these layers are the software equivalent of the UART hardware interface described above, and provide increased portability to the lower level protocol driver 33. Thus, the lower level protocol driver 33 may communicate with the peripheral driver 34 through this serial communication interface. Two separate cases can arise in this preferred embodiment:

In the first case, requests and answers conform with the lower level protocol are encapsulated and exchanged character by character between the lower level protocol driver 33 and the peripheral driver 34, as for a serial communication line. Encapsulation consists of additional information (called meta information) about requests (for example such as their length or criticality) so that the peripheral driver can choose an appropriate transmission mode on the higher level communication network, for example:

if the peripheral driver 34 knows the size of the message to be sent and/or received, it can wait until it has the entire message to transmit it on the higher level network or to the lower level protocol driver 33;

if the peripheral driver 34 knows the criticality of the message to be transmitted on the higher level network, it can choose between different communication channels. Typically, for a critical and short request such as a stop order, it uses a communication channel with a guaranteed pass band if there is one. The guaranteed pass band may be negotiated during the connection in cooperation with the resident driver program 16, and the connection may be refused if the pass band is not available. On the other hand, for a non-critical long request, it uses a communication channel with a non-guaranteed pass band, which avoids degrading communication between the higher level equipment and other peripherals;

the meta information may also denote alternatives in the lower level protocol, that are sufficiently similar to be processed by the same lower level protocol drivers and the same conversion programs 15.

The second case applies to the use of a lower level protocol driver 33 as similar as possible to existing drivers. Since the communication consists of requests and answers, the driver 33 sends and receives exactly the characters making up these requests and answers. The peripheral driver 34 limits itself to transmitting characters without understanding their meaning.

According to another implementation, the communication interface is not conform with the specification for serial peripheral drivers. It is specific to the interaction between the peripheral driver 34 and the protocol driver 33.

This implementation corresponds to the case in which it is useful to have a peripheral solution typically external to the higher level equipment, with an industrial lower level protocol necessitating a communication coprocessor such as WorldFIP, FIP, Interbus-S, DeviceNet, etc. In this case, the existence of several versions of the same protocol or the existence of several similar but separate implementations, is a means of handling the differences while using the same low level peripheral driver 34 and the same adapter, by substituting program variants 15 and 33. In the extreme case, the drivers 33 and 34 could be combined in a single entity.

This implementation also corresponds to the case in which the lower level protocol is specific to a lower level automation equipment 40 and is based on USB. The lower level equipment 40 then has a master USB interface and cannot directly dialog with the higher level equipment 30 that is also master. The adapter acts as a slave on the higher level network and on the lower level network and the conversion program 15 acts as a bridge between the two networks.

The conversion program 15 uses a buffer memory area 17 located in the first memory 25 of the adapter 20 to adapt to any asynchronism between the higher and lower level protocols. FIGS. 3 and 4 show an example illustration of the use of a buffer memory 17. FIG. 3 shows communication between slave equipment on the higher level 30 and any equipment on the lower level 40 using a lower level protocol based on a half-duplex serial link. In this FIG. 3, the adapter device described in the invention is not used. The higher level equipment 30 receives a request consisting of five characters C1 to C5 to which it must reply by sending four characters C6 to C9. In particular, this could be a polling exchange. The higher level equipment must be capable of detecting the maximum time i between characters and the minimum silence time t between messages. As mentioned at the beginning of this presentation, these waiting times, typically between 100 microseconds and one millisecond, are a constraint that is difficult to manage for PC type equipment on the higher level in a Windows™ environment.

In FIG. 4, communication between equipment 30 and equipment 40 passes through an adapter 20 according to the invention. Exchanges between the lower level equipment 40 and the adapter 20 are made using the lower level protocol and exchanges between the adapter and the higher level equipment 30 are made according to the higher level protocol. Therefore, the adapter 20 receives the five characters C1 to C5 in the message from the lower level equipment 40 and it will send the four response characters C6 to C9 to the lower level equipment 40. The advantage of this solution is that the processing unit 21 of the adapter 20 is much better adapted to manage the waiting times i and t. The received characters C1 to C5 are stored as they are received in the buffer memory 17 of the adapter 20 before being routed to the higher level equipment once the complete message has been received using the higher level protocol, for example the USB protocol, which is much better managed by the higher level equipment because specific means (higher performance hardware layers—speed, information coding, dedicated processor) can manage the communication using the higher level protocol. Similarly, when the higher level equipment 30 returns its response, the characters C6 to C9 are stored in the buffer memory 17 before being routed one by one, once the complete message has been received, to the lower level equipment using the lower level protocol. In this way, the higher level equipment 30 is released from constraints related to the management of waiting times. Therefore the processing unit 21 is capable of temporarily storing the entire message received from lower level equipment 40 in the buffer memory area 17 before passing it on to the higher level equipment 30, and conversely of temporarily storing the entire message received from the higher level equipment 30 in the buffer memory area 17 before transmitting it to the lower level equipment 40.

To make its operation transparent, the adapter device is provided with a mechanism for selecting the lower level protocol. This mechanism is based on two distinct principles:

The user determines the lower level protocol using a dialog interface that is used to configure the peripheral driver 34 using the associated program 36. This dialogue interface may either be in the higher level equipment (one or more specific screens) or on the adapter (for example a set of switches or an encoder wheel). The peripheral driver 34 can then download the conversion program 15 as soon as it starts (which is controlled by the adapter connection).

A recognition means is included in the lower level cable 14. This case is applicable when the invention uses a lower level cable 14 which, in the situation preceding the invention, already comprises a natural means of recognition (PCMCIA card, loop in the cable, identification key, or any other equivalent means).

This case is also applicable when new cables are specifically designed for the invention (short lower level cables). Operation of the downloading phase of the conversion program 15 is then more complex. It is then assumed that the connecting cable 14 comprises integrated recognition means that can be detected when the cable 14 is connected to the lower level interface 24 of the adapter 20. They enable the processing unit 21 to determine a lower level protocol identifier 18 corresponding to the target 14, using the resident driver program 16. Therefore each different lower level protocol may use a different cable 14. The identifier 18 may either be complete 18b, in other words it may completely determine the lower level protocol, or it may be partial 18a, in other words it cannot identify the lower level protocol completely by itself. All that a partial identifier 18a can do is to start sufficient communication between the adapter 20 and the lower level equipment 40 to completely learn the lower level protocol. For example, it is thus possible to identify the exact version of the lower level protocol, since this information changes too quickly to be contained in the partial identifier 18a read on the cable 14.

We will now describe the configuration process for the adapter device with reference to FIG. 2.

In a preliminary step called the recognition step R, the adapter 20 uses the resident driver program 16 to determine a partial identifier 18a or a complete identifier 18b of a lower level protocol using means of recognition consisting of a lower level connecting cable 14 connected to the adapter 20. This identifier is memorized in the first memory 25 of the adapter.

During a first identification step I1, the resident driver program 16 in the adapter 20 then initialises the communication between the higher level equipment 30 using the higher level protocol and transmits the partial identifier 18a or the complete identifier 18b of the lower level protocol determined during step R, to the higher level equipment. The transmission may take place at the initiative of the resident driver program 16 of the adapter 20 by transmission of an event to the higher level equipment 30 if possible using the higher level protocol, or by periodic scanning at the initiative of the peripheral driver 34 running in the higher level equipment 30.

Then, during an initial downloading step T1, the control program 36 of the higher level equipment 30 analyses the partial identifier 18a or the complete identifier 18b and selects a first conversion program 15 corresponding to the identifier 18a, 18b, in the storage are 35, to load this conversion program into the first memory 25 of the adapter 20.

If the identifier 18 of the lower level protocol was complete 18b, the configuration process is then complete and communication can be set up between the higher level equipment 30 and the lower level equipment 40 through a conversion program 15 loaded in the adapter 20.

If the identifier 18 of the lower level protocol was partial 18a, the configuration process continues with the learning step A during which the conversion program 15 downloaded in step T1 will initialise a communication with the lower level protocol driver 43 of the lower level equipment 40 in order to completely specify the lower level protocol used. During this learning step A, the conversion program 15 may for example attempt to set up a communication with the lower level equipment 40 by sending different requests conform with different types or different versions of lower level protocols, and then test any responses from the lower level equipment 40 to determine the lower level protocol that is actually present in the lower level equipment 40. At the end of this learning step, the complete identifier 18a of the lower level protocol is identified and loaded into the first memory 25.

This complete identifier 18b is then transmitted in a second identification step 12 by the resident driver program 16 of the adapter 20 to the higher level equipment 30 according to the higher level protocol.

The control program 36 of the higher level equipment 30 analyses the identifier 18b and selects a second conversion program 15′ in the storage area 35, corresponding to the complete identifier l8b so that this conversion program can be downloaded into the first memory 25 of the adapter 20 during a second downloading step T2. After this step T2, communication can be set up normally between the higher level equipment 30 and the lower level equipment 40 through the conversion program 15′, and the configuration process is then terminated.

However, it would be quite possible that the identifier 18 will still not be complete after the second downloading step T2, and therefore the configuration process has to be looped back to an additional learning step A in order to define the lower level protocol more completely (for example to determine the exact version of the lower level protocol used). In this case there is another step I2 and then another step T2.

Advantageously, the invention must be able to reuse some existing standard cables 14, particularly the cables supplied with the loop back link. For example, the adapter 20 can use means of recognition of a standard lower level connecting cable 14 to determine a partial identifier 18a indicating that the lower level protocol is based on an RS-485 type link. With this information sent to the higher level side equipment 30, the control program 36 is capable of choosing and downloading a first conversion program 15 into the first memory 25. To define a complete identifier 18b of the lower level protocol, this conversion program 15 can then send different requests in sequence to the lower level equipment 40 using an RS-485 type link, for example using the MODBUS protocol, or the Uni-Telway protocol, or others, in order to test the requests which will be actually understood, and which will be followed by a satisfactory response from the lower level equipment 40. This function can determine the nature and version of the lower level protocol used by the lower level equipment 40. This enables the adapter device to adapt to a very wide variety of lower level equipment with the same higher level equipment provided that the higher level equipment stores appropriate conversion programs. In practice, it would then be easy to communicate with recent or old automation equipment from a single PC type computer, transparently for a user, without needing to be concerned with compatibility between the lower level interface of the automation equipment (serial port) and the higher level interface of the computer (for example USB port).

When the lower level connecting cable 14 is previously connected to adapter 20, the process starts when the adapter 20 is connected to the higher level equipment 30 or at the request of the adapter 20. When the adapter 20 is previously connected to the higher level equipment 30, the process is started when the lower level connecting cable 14 is connected to the adapter 20.

As an alternative, there are other means of passing from a partial identifier 18a to a complete identifier 18b. For example, it would be possible to consider an operator dialogue interface such as encoder wheels that would enable a user to select the lower level protocol himself. Also in some cases, special software in the higher level 30 could be sufficient to deduce a complete identifier 18b starting from a partial identifier 18a determined by means of recognition of the lower level connecting cable 14. The control program 36 would then be capable of directly downloading the final conversion program 15′.

Another alternative is that the resident driver program 16 would be capable of modifying the identifier 18 before sending it to the higher level equipment 30 such that the conversion program 15 downloaded during a downloading step T1, T2, depends on the software version of the adapter 20.

Obviously, it would be possible to imagine other alternatives and improvements to detail, and even to envisage the use of equivalent means, without departing from the scope of the invention.

1. Programmable adapter device between a higher level communication protocol supported by a higher level equipment (30) and at least one lower level communication protocol supported by the lower level automation equipment (40), the device comprising an adapter (20) fitted with a processing unit (21) capable of executing program instructions, a higher level interface (23) that can connect with a higher level interface (32) in the higher level equipment (30), and a lower level interface (24) that can connect with a lower level interface (42) on the lower level equipment(40), wherein:
the adapter (20) comprises a first memory (25) containing a conversion program (15) between the higher level protocol and a lower level protocol, that can be downloaded from the higher level equipment (30) and executed by the processing unit (21) in the adapter (20),
the adapter (20) comprises a second non-volatile memory (26) containing a resident driver program (16) that can be executed by the processing unit (21) in order to initialise communication with the higher level equipment (30) using the higher level communication protocol and download the conversion program (15) into the first memory (25).

2. Adapter device according to claim 1, wherein the first memory (25) of the adapter (20) is a volatile memory.

3. Adapter device according to claim 2, wherein the first memory (25) of the adapter (20) contains a buffer memory area (17) used by the conversion program (15) to adapt to asynchronism between the higher level and lower level protocols.

4. Adapter device according to claim 3, wherein the conversion program (15) executed by the processing unit (21) stores messages received from a lower level equipment (40) in the buffer memory area (17) before passing them onto the higher level equipment (30).

5. Adapter device according to claim 3, wherein the conversion program (15) executed by the processing unit (21) stores messages received from the higher level equipment (30) in the buffer memory area (17) before passing them onto a lower level equipment (40).

6. Adapter device according to claim 1, comprising a lower level connecting cable (14) between the lower level interface (24) of the adapter (20) and the lower level interface (42) of the lower level equipment (40), wherein the lower level connecting cable (14) contains integrated recognition means, detectable when the cable (14) is connected to the lower level interface (24) of the adapter (20), enabling the processing unit (21) of the adapter (20) to determine a complete identifier (18b) or a partial identifier (18a) of the lower level protocol using the resident driver program (16).

7. Adapter device according to claim 6, wherein the complete identifier (18b) or the partial identifier (18a) of the lower level protocol is memorized in the first memory (25) of the adapter (20).

8. Adapter device according to claim 1, wherein the device also comprises a storage area (35) in the higher level equipment (30) in order to store one or several conversion programs (15, 15′) between the higher level protocol and a lower level protocol, that can be downloaded in the first memory (25) of the adapter (20).

9. Adapter device according to claim 8, wherein the higher level equipment (30) comprises at least one lower level protocol driver (33) and at least one peripheral driver (34) supporting a serial communication interface, such that the lower level protocol driver (33) communicates with the peripheral driver (34) through this serial communication interface.

10. Adapter device according to claim 9, wherein the peripheral driver (34) of the higher level equipment (30) uses different communication channels as a function of the criticality of the messages to be transmitted, to exchange messages with the resident driver program (16).

11. Adapter device according to claim 1, wherein the USB protocol is used as the higher level communication protocol.

12. Adapter device according to claim 11, wherein the adapter (20) is supplied by the USB interface of the higher level equipment (30).

13. Adapter device according to claim 1, wherein the higher level communication protocol is the BLUETOOTH protocol.

14. Adapter device according to claim 1, wherein the higher level communication protocol is a protocol conform with the IEEE 1394-1995 standard.

15. Adapter device according to claim 1, wherein the lower level communication protocol is one of the ModBus, ModBus+, Uni-Telway or any other protocol using an RS-232, RS-485, RS-422 or current loop as the physical layer.

16. Adapter device according to claim 1, wherein the lower level communication protocol is a protocol based on the Ethernet and TCP/IP standards.

17. Adapter device according to claim 1, wherein the lower level communication protocol is selected from a group composed of the FIP, CAN, CANopen, Interbus-S, DeviceNet protocols.

18. Adapter device according to claim 1, wherein the lower level communication protocol is a communication protocol based on the USB protocol.

19. Configuration process used in an adapter device according to one of the previous claims, the process comprising:
a recognition step (R) in which the adapter (20) determines and memorizes a partial identifier (18a) or a complete identifier (18b) of a lower level protocol starting from means of recognising the lower level connecting cable (14) connected to the adapter (20),
a first identification step (I1) in which the adapter (20) communicates with the higher level equipment (30) using the higher level communication protocol to transmit the partial identifier (18a) or the complete identifier (18b) of the lower level protocol, to the higher level equipment,
a first downloading step (T1) in which the higher level equipment (30) downloads a first conversion program (15) between the higher level protocol and the lower level protocol, into the adapter (20), corresponding to the partial identifier (18a) or the complete identifier (18b) of the transmitted lower level protocol.

20. Configuration process according to claim 19, wherein, when the lower level protocol identifier transmitted to the higher level equipment (30) during the first identification step (I1) is a partial identifier (18a), the process comprises the following additional steps:
a learning step (A) in which the adapter (20) communicates with the lower level equipment (40) using the first conversion program (15) downloaded during the first downloading step (T1) in order to define and memorize a complete identifier (18b) of the lower level protocol,
a second identification step (I2) in which the adapter (20) communicates with the higher level equipment (30) to transmit this complete identifier (18b) to the higher level equipment,
a second downloading step (T2) in which the higher level equipment (30) downloads a second conversion program (15′) between the higher level protocol and the lower level protocol, into the adapter (20), corresponding to the complete identifier (18b) of the lower level protocol.

21. Configuration process according to claim 19, wherein, when the lower level connecting cable (14) is previously connected to the adapter (20), the process is started when the adapter (20) is connected to the higher level equipment (30) or at the request of the adapter (20).

22. Configuration process according to claim 19, wherein, when the adapter (20) is previously connected to the higher level equipment (30), the process is started when the lower level connecting cable (14) is connected to the adapter (20).
